(19) United States
(12) Patent Application Publication
(10) Pub. No.: US 2016/0321810 A1
(43) Pub. Date: Nov. 3, 2016

(54) OPTICAL NAVIGATION SENSOR, ELECTRONIC DEVICE WITH OPTICAL NAVIGATION FUNCTION AND OPERATION METHOD THEREOF

(71) Applicant: PixArt Imaging (Penang) SDN. BHD., Penang (MY)

(72) Inventors: Siew-Chin Lee, Penang (MY); Wui-Pin Lee, Penang (MY)

(21) Appl. No.: 14/698,272

(22) Filed: Apr. 28, 2015

(51) Int. Cl. G06T 7/00; G06T 7/20

(52) U.S. Cl. CPC G06T 7/0044; G06T 7/0085; G06T 7/2033; G06T 7/0097; G06T 7/2013; G06T 2207/20021

(57) ABSTRACT

The present disclosure illustrates an optical navigation sensor. The optical navigation sensor comprises a pixel array, a navigation unit and an edge detection unit. The pixel array is configured for capturing an image once every capturing interval. The navigation unit is configured for generating a navigation signal according to the images. The edge detection unit configured for generating an edge detection signal according to the images and the navigation signal. When the rotation unit performs a rotation action, the pixel array starts to capture the image associated with the surface. The navigation unit determines a rotation direction of the rotation unit in response to the images and generates the navigation signal. The edge detection unit receives the navigation signal and the images, and generates the edge detection signal in response to the rotation direction and the number of the recognition block which passes a sensing area.

### BACKGROUND

1. Technical Field

The present disclosure relates to an optical navigation sensor, in particular, to an optical navigation sensor with an edge detection function, an electronic device with the optical navigation sensor and operation method thereof.

2. Description of Related Art

With the development and growth of technology, more and more electronic devices have an optical navigation function. These electronic devices include an optical navigation sensor to implement the optical navigation function. Besides of optical mousse, the optical navigation sensors widely applied to other electronic devices, for example, a volume control knob of a sound system.

The optical navigation sensor provides a light beam to a surface of an object through a light emitting diode, and captures images based upon a reflected light which the surface of the object reflects the light beam. Then, the optical navigation sensor compares the image which is captured currently with the image which is captured previously, and calculates an amount of displacement.

However, a conventional optical navigation sensor has a problem: if a pixel array of the optical navigation sensor can not accurately sense the images associated with the surface of the object, the amount of displacement calculated by the optical navigation sensor is not equal to an actual amount of displacement. Hence, how to improve accuracy when the optical navigation sensor calculates the amount of displacement is a problem within a technical field.

### SUMMARY

An exemplary embodiment of the present disclosure provides an optical navigation sensor. The optical navigation sensor is configured for operatively sensing a surface of a rotation unit which the surface alternately disposes at least one recognition block. The optical navigation sensor comprises a pixel array, a navigation unit and an edge detection unit. The navigation unit is coupled to the pixel array. The edge detection unit is coupled to the pixel array and the navigation unit. The pixel array is configured for operatively capturing an image once every capturing interval. The navigation unit is configured for operatively generating a navigation signal according to the images. The navigation signal comprises a rotation direction of the rotation unit. The edge detection unit is configured for operatively generating an edge detection signal according to the images and the navigation signal. The edge detection signal comprises a number of the recognition block which passes a sensing area of the pixel array. When the rotation unit performs a rotation action, the pixel array of the optical navigation sensor starts to capture the image associated with the surface. After receiving at least two images, the navigation unit determines the rotation direction of the rotation unit in response to the images which shows a position variation of the recognition block in the images and generates the navigation signal. The edge detection unit receives the navigation signal and the images, and generates the edge detection signal in response to the rotation direction and the number of the recognition block which passes the sensing area.

An exemplary embodiment of the present disclosure provides an electronic device with an optical navigation function. The electronic device comprises a rotation unit and an optical navigation sensor. The rotation unit comprises a surface. At least one recognition block is alternately disposed on the surface, and light reflection coefficients between the surface and the recognition block are different. The optical navigation sensor is configured for operatively sensing the surface. The optical navigation sensor comprises a pixel array, a navigation unit and an edge detection unit. The navigation unit is coupled to the pixel array. The edge detection unit is coupled to the pixel array and the navigation unit. The pixel array is configured for operatively capturing an image once every capturing interval. The navigation unit is configured for operatively generating a navigation signal according to the images. The navigation signal comprises a rotation direction of the rotation unit. The edge detection unit is configured for operatively generating an edge detection signal according to the images and the navigation signal. The edge detection signal comprises a number of the recognition block which passes a sensing area of the pixel array. When the rotation unit performs a rotation action, the pixel array of the optical navigation sensor starts to capture the image associated with the surface. After receiving at least two images, the navigation unit determines the rotation direction of the rotation unit in response to the images which shows a position variation of the recognition block in the images and generates the navigation signal. The edge detection unit receives the navigation signal and the images, and generates the edge detection signal in response to the rotation direction and the number of the recognition block which passes the sensing area.

An exemplary embodiment of the present disclosure provides an operation method of an electronic device. The electronic device comprises a rotation unit and an optical navigation sensor, and the optical navigation sensor comprising a pixel array, a navigation unit and an edge detection unit. The method comprising the steps of: step (a): at the rotation unit, performing a rotation action. The rotation unit comprises a surface, and at least one recognition block is alternately disposed on the surface, and light reflection coefficients between the surface and the recognition block are different. Step (b): at the pixel array, sensing the surface and capturing an image once every capturing interval. Step (c): at the navigation unit, after receiving at least two images, determining a rotation direction of the rotation unit in response to the images which shows a position variation of the recognition block in the images, and generating a navigation signal. The navigation signal comprises the rotation direction of the rotation unit. Step (d): at the edge detection unit, receiving the navigation signal and the images, and generating an edge detection signal in response to the rotation direction and a number of the recognition block which passes a sensing area of the pixel array. The edge detection signal comprises the number of the recognition block which passes the sensing area. Step (e): determining a rotation state of the rotation unit in response to the navigation signal and the edge detection signal. The rotation state comprises the rotation direction of the rotation unit and the number of the recognition block which passes the sensing area.

To sum up, compared to a conventional optical navigation sensor, the optical navigation sensor, the electronic device and the operation method provided by the present disclosure utilize the navigation unit to determine an amount of displacement of the rotation unit, and utilize the edge detection unit to detect the recognition block disposed on the surface of the rotation unit. By the rotation unit and the edge detection unit, the optical navigation sensor provided by the present disclosure can calculate the amount of displacement of the rotation unit more accurate, such that a back-end circuit can perform a corresponding action according to the calculated amount of displacement of the rotation unit.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic diagram illustrating an electronic device with the optical navigation function in accordance with an exemplary embodiment of the present disclosure.

FIG. 2A to FIG. 2B are schematic diagrams illustrating electronic devices with the optical navigation functions in accordance with another exemplary embodiments of the present disclosure.

FIG. 3A to FIG. 3D are schematic diagrams illustrating distribution of at least one recognition block in accordance with exemplary embodiments of the present disclosure.

FIG. 4 is a block diagram illustrating an optical navigation sensor in accordance with an exemplary embodiment of the present disclosure.

FIG. 5A to FIG. 5B are schematic diagrams illustrating rotation units in accordance with exemplary embodiments of the present disclosure.

FIG. 6A to FIG. 6D are schematic diagrams illustrating a rotation unit when performing a rotation action in accordance with an exemplary embodiment of the present disclosure.

FIG. 7A to FIG. 7D are schematic diagrams illustrating a rotation unit when performing a rotation action in accordance with another exemplary embodiment of the present disclosure.

FIG. 8 is a block diagram illustrating an optical navigation sensor in accordance with another exemplary embodiment of the present disclosure.

FIG. 9 is a flow diagram illustrating an operation method of an electronic device in accordance with an exemplary embodiment of the present disclosure.

FIG. 10 is a flow diagram illustrating a generation of an edge detection signal in accordance with an exemplary embodiment of the present disclosure.

### DESCRIPTION OF THE EXEMPLARY EMBODIMENTS

The aforementioned illustrations and detailed descriptions are exemplarity for the purpose of further explaining the scope of the instant disclosure. Other objectives and advantages related to the instant disclosure will be illustrated in the subsequent descriptions and appended drawings.

Hereinafter, the concept of the present invention may be embodied in many different forms and should not be construed as limited to the exemplary embodiment set forth herein. Rather, the exemplary embodiments are provided so that the instant disclosure will be thorough, complete, and will fully convey the scope of the inventive concept by those skilled in the art. For the purpose of viewing, the relative sizes of layers and regions are exaggerated in all drawings, and similar numerals indicate like elements.

Notably, the terms first, second, third, etc., may be used herein to describe various elements or signals, but these signals should not be affected by such elements or terms. Such terminology is used to distinguish one element from another or a signal with another signal. Further, the term “or” as used herein in the case may include any one or combinations of the associated listed items.

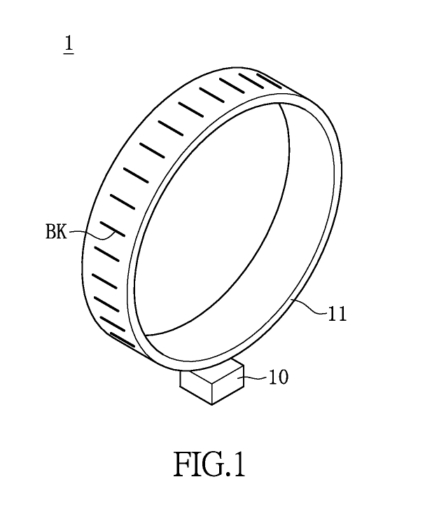

Please refer to FIG. 1, which shows a schematic diagram illustrating an electronic device with the optical navigation function in accordance with an exemplary embodiment of the present disclosure. The electronic device 1 comprises an optical navigation sensor 10 and a rotation unit 11. The optical navigation sensor 10 is disposed corresponding to a surface of the rotation unit 11. The optical navigation sensor 10 is configured for operatively sensing the surface of the rotation unit 11 and capturing an image.

At least one recognition block BK is alternately disposed on the surface of the rotation unit 11. Light reflection coefficients between the surface and the recognition block BK are different. The rotation unit 11 can perform a rotation action. For example, when the rotation unit 11 performs the rotation action, the rotation unit 11 rotates around a center of the rotation unit 11.

In the exemplary embodiment of the present disclosure, the rotation unit 11 is a ring structure. The recognition block BK is disposed on an outer surface of the rotation unit 11. The optical navigation sensor 10 is disposed corresponding to the outer surface of the rotation unit 11.

Due to the light reflection coefficients between the outer surface and the recognition block BK are different from each other, a light intensity of a reflected light reflected by the outer surface is different from a light intensity of a reflected light reflected by the recognition block BK. The optical navigation sensor 10 captures the image based upon the reflected light, and determines a number of the recognition block BK passing a sensing area of the optical navigation sensor 10 when the rotation unit 11 performs the rotation action. Then, the optical navigation sensor 10 calculates an amount of the displacement of the rotation unit 11 in response to the image and the number of the recognition block BK passing the sensing area of the optical navigation sensor 10.

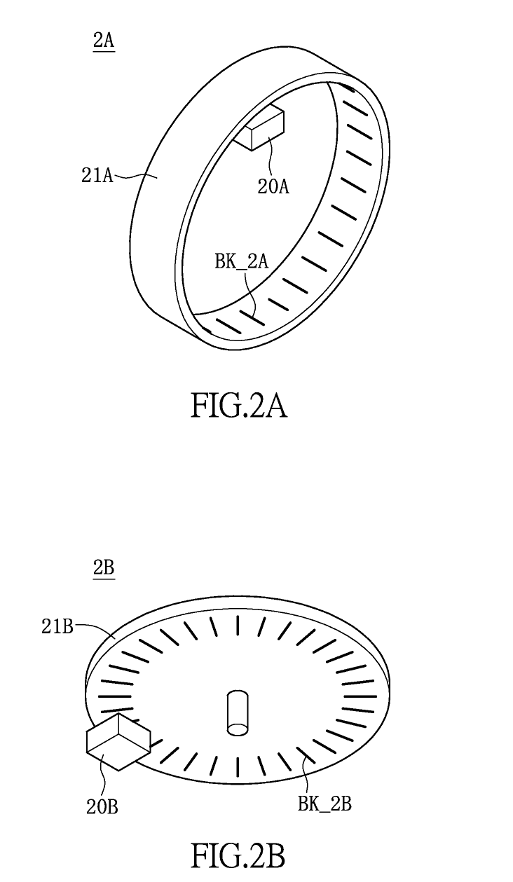

Please refer to FIG. 2A to FIG. 2B, which show schematic diagrams illustrating electronic devices with the optical navigation functions in accordance with another exemplary embodiments of the present disclosure. An electronic device 2A shown in FIG. 2A is also a ring structure. Being different from the electronic device 1 shown in FIG. 1, at least one recognition block BK_2A in FIG. 2A is disposed on an inner surface of a rotation unit 21A. An optical navigation sensor 20A is disposed corresponding to the inner surface of the rotation unit 21A. When the rotation unit 21A performs a rotation action, the optical navigation sensor 20A senses the inner surface of the rotation unit 21A and captures an image.

Being different from the electronic device 1 shown in FIG. 1 and the electronic device 2A shown in FIG. 2A, a rotation unit 2B of the electronic device 2B shown in FIG. 2B is a dish structure. In FIG. 2B, at least one recognition block BK_2B is disposed on a lower surface of a rotation unit 21B. An optical navigation sensor 20B is disposed corresponding to the lower surface of the rotation unit 21B. When the rotation unit 21B performs a rotation action, the optical navigation sensor 20B senses the lower surface of the rotation unit 21B and captures an image. Notably, in another exemplary embodiment of the present disclosure, the recognition block BK_2B also can be disposed on an upper surface of the rotation unit 21B, and the optical navigation sensor 20B is disposed corresponding to the upper surface of the rotation unit 21B.

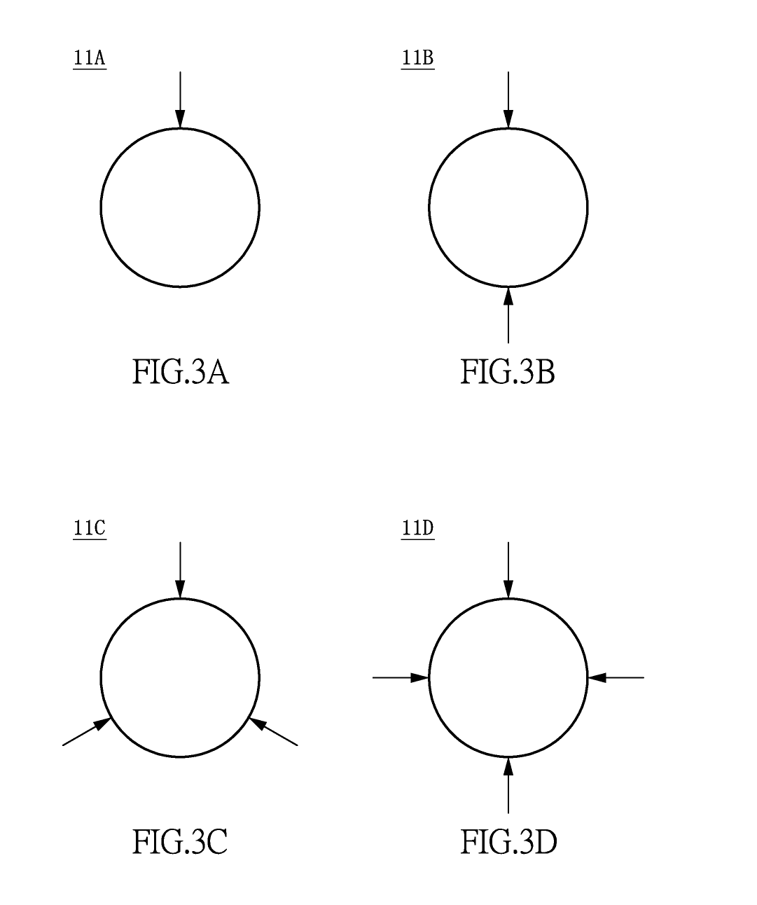

Next, a distribution of the recognition block BK will be introduced. Please refer to FIG. 3A to FIG. 3D, which show schematic diagrams illustrating distribution of at least one recognition block in accordance with exemplary embodiments of the present disclosure. In FIG. 3A, a rotation unit 11A includes one recognition block BK. The recognition block BK is disposed on any position of a surface of the rotation unit 11A. In FIG. 3B, a rotation unit 11B includes two recognition blocks BK. Positions of the two recognition blocks BK are indicated by two arrows shown in FIG. 3B, the two recognition blocks BK are separated by 180 degrees with each other. In FIG. 3C, a rotation unit 11C includes three recognition blocks BK. Positions of the three recognition blocks BK are indicated by three arrows shown in FIG. 3C, the each two neighboring recognition blocks BK are separated by 120 degrees with each other. In FIG. 3D, a rotation unit 11D includes four recognition blocks BK. Positions of the four recognition blocks BK are indicated by four arrows shown in FIG. 3D, the each two neighboring recognition blocks BK are separated by 90 degrees with each other.

Notably, the distribution of the recognition blocks BK is not limited to the examples provided in the exemplary embodiment. For example, if the rotation unit includes N recognition blocks BK, the recognition blocks BK are separated by 360/N degrees with each other. From the explanation of the aforementioned exemplary embodiment, those skilled in the art should be able to deduce the other exemplary embodiments according to the disclosure of the present disclosure, as long as each neighboring two recognition blocks BK are separated from each other in the same angle, and further descriptions are therefore omitted.

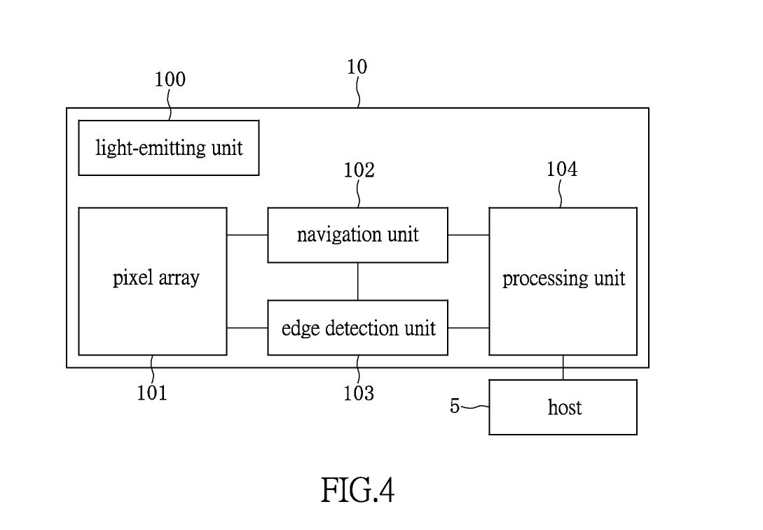

Next, an optical navigation sensor will be introduced. Please refer to FIG. 4, which shows a block diagram illustrating an optical navigation sensor in accordance with an exemplary embodiment of the present disclosure. The optical navigation sensor 10 includes a light-emitting unit 100, a pixel array 101, a navigation unit 102, an edge detection unit 103 and a processing unit 104. The pixel array 101 is coupled to the navigation unit 102 and the edge detection unit 103. The navigation unit 102 is coupled to the edge detection unit 103 and the processing unit 104. The edge detection unit 103 is coupled to the processing unit 104.

The light-emitting unit 100, such as a light-emitting diode (LED), is configured for operatively providing a light beam to irradiate a surface of a rotation unit (not shown in FIG. 4, such as the rotation unit 11 shown in FIG. 1).

The pixel array 101 includes a plurality of pixel units. The pixel array 101 is disposed corresponding to a surface of the rotation unit 11. The pixel array 101 receives a reflected light which the surface of the rotation unit 11 reflects the light beam provided by the light-emitting unit 100, and captures an image in response to the reflected light once every capturing interval, wherein the images are associated with a part of the surface of the rotation unit 11.

The navigation unit 102 is configured for operatively determining a rotation direction when the rotation unit 11 performs the rotation action based upon the images captured by the pixel array, and generating a navigation signal. The navigation signal comprises the rotation direction of the rotation unit 11.

The edge detection unit 103 is configured for operatively receiving the images and the navigation signal outputted by the navigation unit 102, and generating an edge detection signal in response to the images and the navigation signal. The edge detection signal comprises a number of the recognition block BK which passes a sensing area of the pixel array 101 within the rotation action.

The processing unit 104 receives the navigation signal and the edge detection signal, and determines a rotation state of the rotation unit 11 in response to the navigation signal and the edge detection signal to generate a rotation state signal. The rotation state comprises the rotation direction of the rotation unit 11 and the number of the recognition block BK passed the sensing area of the pixel array 101 within the rotation action. The processing unit 104 outputs the rotation state signal to a host 5. The host 5 can be a desk computer, a notebook computer or other types of computers. The host 5 establishes a connection with the optical navigation sensor 10 through a wire transmission or a wireless transmission. After receiving the rotation state signal, the host 5 implements a corresponding function based upon the rotation direction of the rotation unit 11 and the number of the recognition block BK passing the sensing area of the pixel array 101 which are instructed in the rotation state signal. Or, the host 5 can be an embedded controller which is set in the electronic device 1, and the embedded controller generates a control signal in response to the rotation state signal to control associated circuits

It is worth to note that, in another exemplary embodiment, the optical navigation sensor 10 does not include the processing unit 104. Instead, the navigation unit 102 and the edge detection unit 103 directly connect to the host 5 through the wire transmission or the wireless transmission. The navigation unit 102 outputs the navigation signal to the host 5. The edge detection unit 103 outputs the edge detection signal to the host 5. The host 5 determines the rotation state of the rotation unit 11 in response to the navigation signal and the edge detection signal. Similarly, the rotation state comprises the rotation direction of the rotation unit 11 and the number of the recognition block BK passed the sensing area of the pixel array 101 within the rotation action. After determining the rotation state of the rotation unit 11, the host 5 implements the corresponding function based upon the rotation state.

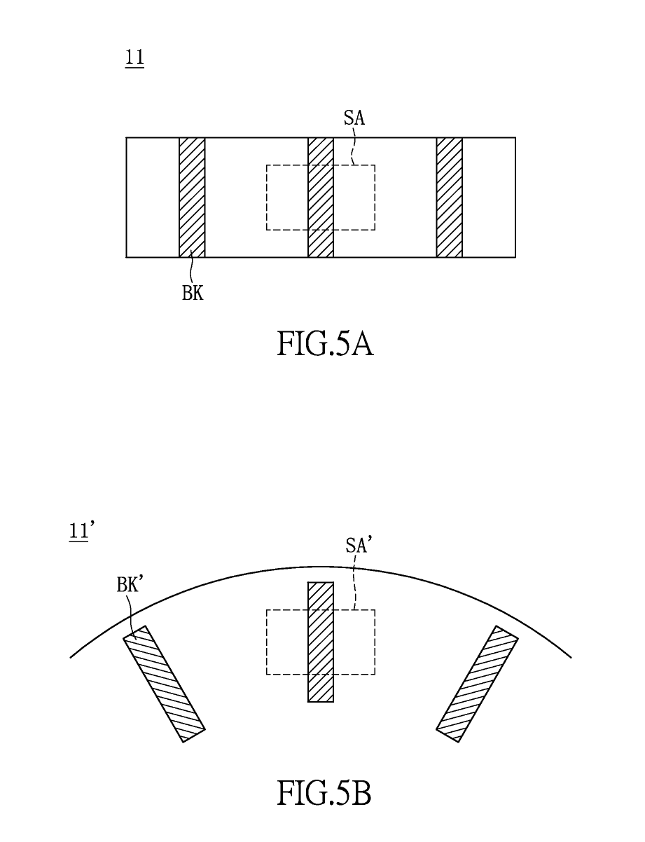

Please refer to FIG. 5A to FIG. 5B, which show schematic diagrams illustrating rotation units in accordance with exemplary embodiments of the present disclosure. The rotation unit 11 shown in FIG. 5A is a ring structure, and the rotation unit 11′ shown in FIG. 5B is a dish structure. As the above descriptions, at least one recognition block BK is alternately disposed on a surface of the rotation unit 11, and at least one recognition block BK′ is alternately disposed on a surface of the rotation unit 11′. For example, there are three recognition blocks BK, BK′ disposed on the surfaces of the rotation unit 11, 11′ respectively in FIG. 5A, 5B.

In FIG. 5A, when the rotation unit 11 starts to perform a rotation action, positions of the recognition blocks BK change and pass sensing area SA of a pixel array (such as the pixel array 101 shown in FIG. 4). The pixel array 101 is disposed corresponding to a surface of the rotation unit 11 for sensing position variations of the recognition blocks BK.

Widths of the recognition blocks BK are respectively smaller than a size of the sensing area SA. The navigation unit 102 can determine a rotation direction of the rotation unit 11 according to the position variations of the recognition blocks BK within the sensing area SA. The edge detection unit 103 can calculate a number of the recognition blocks BK which pass the sensing area SA according to the position variations of the recognition blocks BK within the sensing area SA.

Difference between the rotation unit 11′ shown in FIG. 5B and the rotation unit 11 shown FIG. 5A is that the rotation unit 11′ is the dish structure and the rotation unit 11 is the ring structure. A working principle of the rotation unit 11′ shown in FIG. 5B is similar to a working principle of the rotation unit 11 shown in FIG. 5A, and further descriptions are hereby omitted.

In another exemplary embodiment, the widths of the recognition blocks BK, BK′ can also larger than the sizes of the sensing area SA, SA′. If the widths of the recognition blocks BK, BK′ are larger than the sizes of the sensing area SA, SA′, an optical navigation sensor 10 needs a speed sensor to sensing rotation speed of the rotation unit 11, 11′. A processing unit (as the processing unit 2 shown in FIG. 4) or a host (as the host 5 shown in FIG. 4) determines a rotation state of the rotation unit 11, 11′ in response to the rotation speed, a navigation signal and an edge detection signal. However, in the exemplary embodiment of the present disclosure, the widths of the recognition blocks BK, BK′ are smaller the sizes of the sensing area SA, SA′.

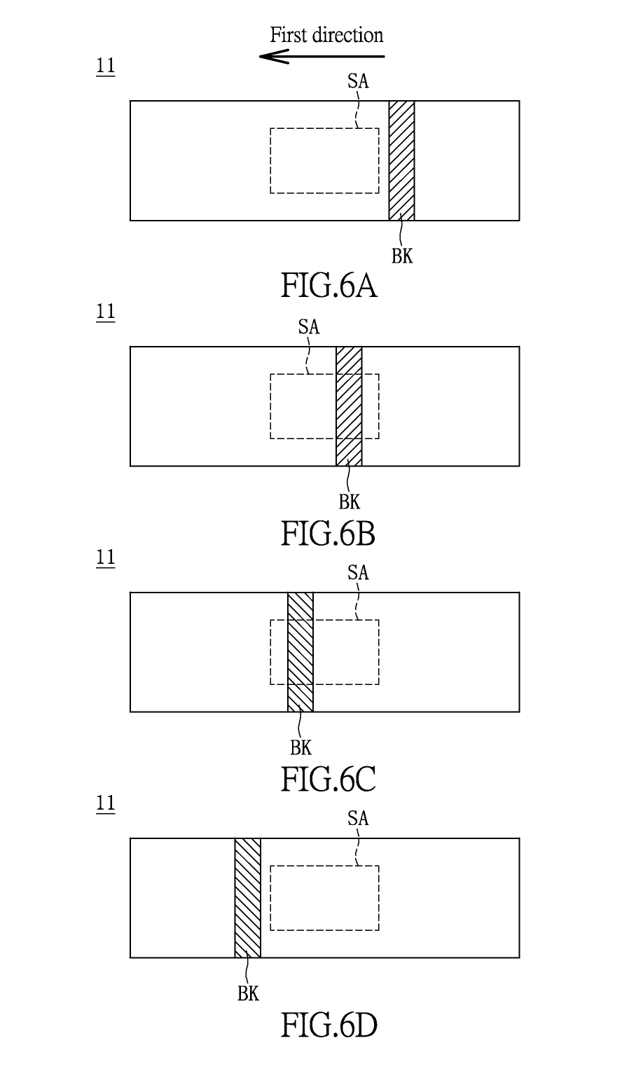

Next, steps of determining a rotation state of a rotation unit 11 by an optical navigation sensor 10 will be introduced. Please refer to FIG. 6A to FIG. 6D, which show schematic diagrams illustrating a rotation unit when performing a rotation action in accordance with an exemplary embodiment of the present disclosure. In the exemplary embodiment, the rotation 11 comprises one recognition block BK. However, the present disclosure is not limited thereto. After referring to the above exemplary embodiments, those skilled in the art should be able to design a number of the recognition block BK disposed on the rotation unit 11 according to concept of the present disclosure.

In the exemplary embodiment, the rotation unit 11 performs a rotation action from right to left. The optical navigation sensor defines a first direction is from right to left. On the other hand, the optical navigation sensor defines a second direction is from left to right. Please refer to FIG. 6A, an initial position of the recognition block BK is on the right side of a sensing area SA. When the rotation unit 11 starts to perform the rotation action, a position of the recognition block BK moves from right to left. Simultaneously, a pixel array 101 starts to capture an image once every capturing interval. The images are associated with a part of a surface of the rotation unit 11.

Please refer to FIG. 6B, a navigation unit 102 and an edge detection unit 103 determine the position of the recognition block BK is within the sensing area SA based upon the images captured by the pixel array 101. To put it concretely, the navigation unit 102 and the edge detection unit 103 detect an edge of the recognition block BK by a search-based edge detection or a zero-crossing based edge detection to obtain the positions of the recognition blocks BK in the corresponding images. The search-based edge detection and the zero-crossing based edge detection are commonly used in image processing technique, thus omitting the redundant description.

Please refer to FIG. 6C, the rotation unit 11 continues performing the rotation action, such that the position of the recognition block BK again moves to the left side. After receiving the image corresponding to FIG. 6C, the navigation unit 102 and the edge detection unit 103 again detect the edge of the recognition block BK. According to a position variation of the recognition block BK in the images shown in FIG. 6B and FIG. 6C, the navigation 102 determines that the rotation unit 11 performs the rotation action with the first direction currently. After determining a rotation direction of the rotation unit 11 is the first direction, the navigation unit 102 generates a navigation signal, and outputs the navigation signal to the edge detection unit 103 and the processing unit 104.

According to the images shown in FIG. 6A to FIG. 6C, the edge detection unit 103 can determine the recognition block BK entering the sensing area SA. When the edge detection unit 103 receives the image shown in FIG. 6D, the edge detection unit 103 determines the recognition block BK has passed the sensing area SA. Then, the edge detection unit 103 adjusts an edge counting value recorded in an edge counter in response to the rotation direction instructed in the navigation signal. The edge counting value is associated with the number of the recognition block BK passing the sensing area SA of the pixel array 101. An initial value of the edge counting value is 0.

In the exemplary embodiment, when the edge detection unit 103 determines the recognition block BK passes the sensing area SA and the rotation direction of the rotation unit 11 is the first direction, the edge counting value of the edge counter increases. For example, the edge counting value is increased by 1. The edge detection unit 103 generates an edge detection signal based upon the edge counting value, and outputs the edge detection signal to the processing unit 104. Briefly, the edge detection unit 103 can determine how many recognition blocks BK pass the sensing area SA based upon the images captured by the pixel array 101, and generate the edge detection signal.

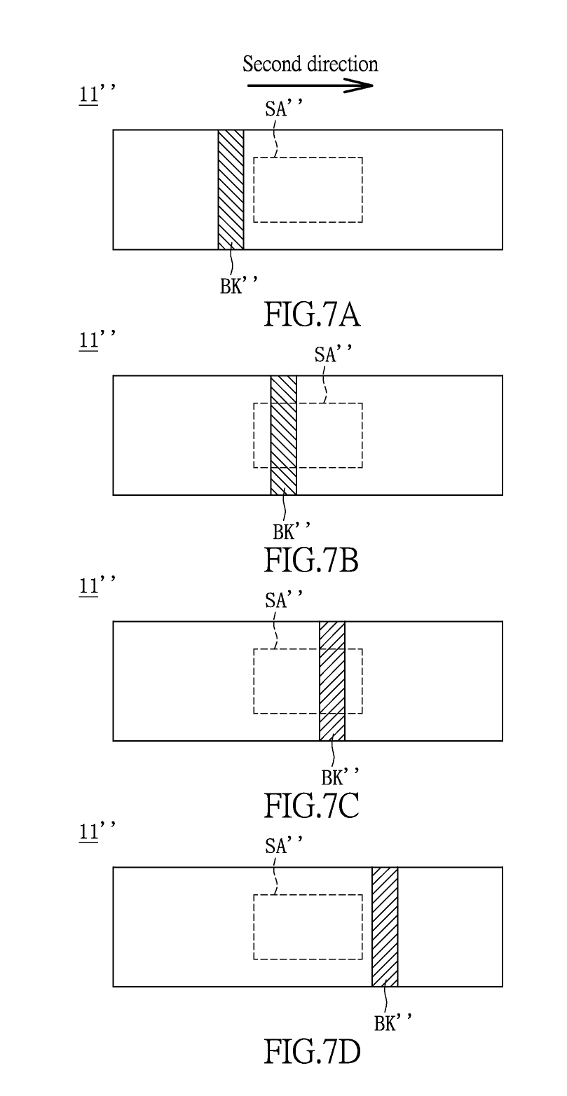

Please refer to FIG. 7A to FIG. 7D, which show schematic diagrams illustrating a rotation unit when performing a rotation action in accordance with another exemplary embodiment of the present disclosure. A rotation unit 11″ shown in FIG. 7A to FIG. 7D comprises one recognition block BK″. Notably, the rotation unit 11″ performs a rotation action from left to right. The optical navigation sensor defines a second direction is from left to right.

Please refer to FIG. 7A, an initial position of the recognition block BK″ is on the left side of a sensing area SA″. When the rotation unit 11″ starts to perform the rotation action, a position of the recognition block BK moves from left to right. Simultaneously, a pixel array 101″ starts to capture an image once every capturing interval. The images are associated with a part of a surface of the rotation unit 11″.

Please refer to FIG. 7B, a navigation unit 102″ and an edge detection unit 103″ detect an edge of the recognition block BK″ by a search-based edge detection or a zero-crossing based edge detection to obtain the positions of the recognition blocks BK″ in the corresponding images.

Please refer to FIG. 7C, the rotation unit 11″ continues performing the rotation action, such that the position of the recognition block BK″ again moves to the right side. After receiving the image corresponding to FIG. 7C, the navigation unit 102″ and the edge detection unit 103″ again detect the edge of the recognition block BK″. According to a position variation of the recognition block BK″ in the images shown in FIG. 7B and FIG. 7C, the navigation 102″ determines that the rotation unit 11″ performs the rotation action with the second direction currently. After determining a rotation direction of the rotation unit 11″ is the second direction, the navigation unit 102″ generates a navigation signal, and outputs the navigation signal to the edge detection unit 103″ and the processing unit 104″.

According to the images shown in FIG. 7A to FIG. 7C, the edge detection unit 103″ can determine the recognition block BK″ entering the sensing area SA″. When the edge detection unit 103″ receives the image shown in FIG. 7D, the edge detection unit 103″ determines the recognition block BK″ has passed the sensing area SA″. Then, the edge detection unit 103″ adjusts an edge counting value recorded in an edge counter in response to the rotation direction instructing in the navigation signal. An initial value of the edge counting value is 0. Notably, the pixel array 101″, the navigation unit 102″, the edge detection unit 103″ and the processing unit 104″ are respectively similar to the pixel array 101, the navigation unit 102, the edge detection unit 103 and the processing unit 104 shown in FIG. 4.

In the exemplary embodiment, when the edge detection unit 103″ determines the recognition block BK″ passes the sensing area SA″ and the rotation direction of the rotation unit 11″ is the second direction, the edge counting value of the edge counter decreases. For example, the edge counting value is decreased by 1. The edge detection unit 103″ generates an edge detection signal based upon the edge counting value, and outputs the edge detection signal to the processing unit 104″.

Incidentally, the first direction is from right to left, and the second direction is from left to right in the exemplary embodiment. However, the first direction and the second direction are not limited to the examples provided by the instant exemplary embodiment. Those skilled in the art can define the first direction and the second direction according to practical demands to complete the present disclosure.

It is worth to note that the processing unit (such as one of the processing units 104, 104″ described above) can reset the edge counting value recorded in the edge counter. When the edge counting value reaches a specific value, the processing unit 104 determines that the rotation unit (such as one of the rotation units 11, 11″ described above) rotates one cycle and returns to an initial rotation position. If the processing unit 104 resets the edge counter, the edge counting value will equal to the initial value. Then, the edge detection unit (such as one of the edge detection units 103, 103″ described above) restarts to calculate the number of the recognition blocks BK passing the sensing areas SA.

The specific value is associated with numbers of the recognition blocks BK disposed on the surface of the rotation unit 11. When there are N recognition blocks BK disposed the surface of the rotation unit 11, the specific value are +N and −N.

For example, when there is one recognition block BK disposed the surface of the rotation unit 11, the specific value is +1 and −1. When the rotation unit 11 performs the rotation action with the first direction, and the recognition block BK passes the sensing area SA, the edge counting value recorded in the edge counter is increased by 1. The edge counting value changes from 0 to 1. After receiving the edge detection signal instructing the edge counting value outputted by the edge detection unit 103, the processing unit 104 determines that the rotation unit 11 rotates one cycle with the first direction. Then, the processing unit 104 commands the edge detection unit 103 to reset the edge counting value recorded in the edge counter.

On the other hand, when the rotation unit 11 performs the rotation action with the second direction, and the recognition block BK passes the sensing area SA, the edge counting value recorded in the edge counter is decreased by 1. The edge counting value changes from 0 to −1. After receiving the edge detection signal illustrating the edge counting value outputted by the edge detection unit 103, the processing unit 104 determines that the rotation unit 11 rotates one cycle with the second direction. Then, the processing unit 104 commands the edge detection unit 103 to reset the edge counting value recorded in the edge counter.

Briefly, whether the rotation unit 11 performs the rotation action with the first direction or the second direction, when the rotation unit 11 rotates one cycle, the edge counting value recorded in the edge counter is reset. Through resetting the edge counting value, the optical navigation sensor 10 can reduce the problem that the number of the recognition block BK passing the sensing area SA calculated by the optical navigation sensor 10 does not match to an actual number of the recognition block BK which passes the sensing area SA within the rotation action, because a cumulative calculation error causing by a deviation between the calculated edge counting value and the actual number of the recognition block BK which passes the sensing area SA is improved by resetting the edge counting value every cycle.

For example, the above optical navigation sensor 10 can be used as a volume control knob of a sound system. The rotation unit 11 performing the rotation action with the first direction means bringing the volume up, and the rotation unit 11 performing the rotation action with the second direction means bringing the volume down. The recognition block BK disposed on the surface of the rotation unit 11 is associated with a volume variation of the sound system. A user can adjust a volume of the sound system by rotating the rotation unit 11. According to the number of the recognition block BK passing the sensing area SA of the optical navigation sensor 10, the processing unit 104 generates a volume control signal and outputs the volume control signal to a back-end circuit (such as the host 5 shown in FIG. 4), such that the host 5 adjusts the volume based upon the volume control signal.

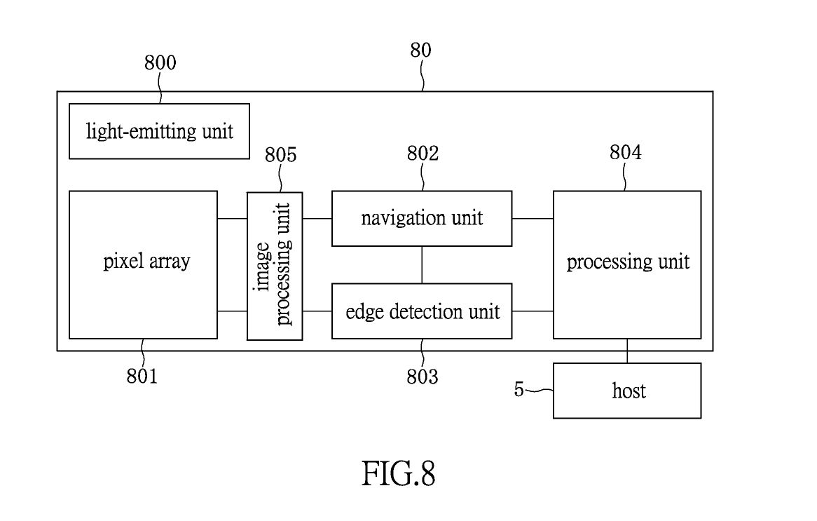

Please refer to FIG. 8, which shows a block diagram illustrating an optical navigation sensor in accordance with another exemplary embodiment of the present disclosure. An optical navigation sensor 80 shown in FIG. 8 comprises a light-emitting unit 800, a pixel array 801, a navigation unit 802, an edge detection unit 803 and a processing unit 804. Functions and connections of each element are similar to that of exemplary embodiment shown in FIG. 4 described above, thus omitting the redundant description, and therefore only differences between them will be described below.

In this exemplary embodiment, the optical navigation sensor 80 further comprises an image processing unit 805. The image processing unit 805 is disposed between the pixel array 801, the navigation unit 802 and the edge detection unit 803. The pixel array 801 is coupled to the image processing unit 805. The image processing unit 805 is coupled to the navigation unit 802 and the edge detection unit 803.

The image processing unit 805 is configured for operatively receiving images outputted by the pixel array 801, and performs image processing on the images to correspondingly generate second images. The image processing such as image brightness compensation or image format conversion. The image processing unit 805 outputs the second images to the navigation unit 802 and the edge detection unit 803. Then, the navigation unit 802 and the edge detection unit 803 respectively generate a navigation signal and an edge detection signal in response to the second images.

Through performing image processing on the images outputted by the pixel array 801, the optical navigation sensor 80 reduces time used in generating the navigation signal and edge detection signal. Because image sizes of the second images are smaller than the images outputted by the pixel array 801 after image format conversion. Furthermore, when the optical navigation sensor 80 calculates an amount of displacement which the rotation unit moves, accuracy calculated by the optical navigation sensor 80 is increased. Because image resolution of the second images are higher than the images outputted by the pixel array 801 after image brightness compensation.

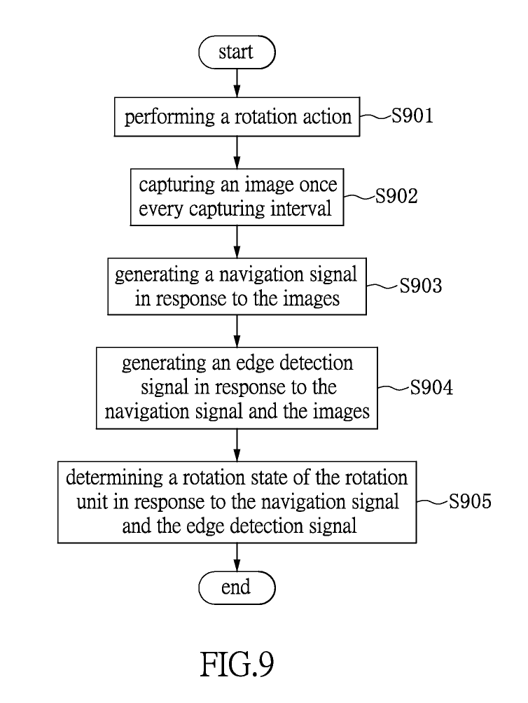

Please refer to FIG. 9, which shows a flow diagram illustrating an operation method of an electronic device in accordance with an exemplary embodiment of the present disclosure. The operation method is applicable to the above electronic devices 1, 2A, 2B. In step S901, a rotation unit performs a rotation action. The rotation unit includes a surface. There is at least one recognition block alternately disposed on the surface, and light reflection coefficients between the surface and the recognition block are different. In step S902, a pixel array senses the surface of the rotation, and captures an image once every capturing interval. The images are associated with a part of the surface of the rotation unit.

In step S903, a navigation unit receives the images outputted by the pixel array. After receiving at least two images, the navigation unit determines a rotation direction of the rotation unit based upon a position variation of the recognition blocks in the images, and generates a navigation signal. The navigation signal instructs the rotation direction of the rotation unit. In step S904, an edge detection unit receives the images and the navigation signal, and generates an edge detection signal in response to the images and the navigation signal. The edge detection signal instructs a number of the recognition block which passes a sensing area of the pixel array within the rotation action. In step S905, a processing unit of the electronic device determines a rotation state of the rotation unit in response to the navigation signal and the edge detection signal. The rotation state comprises the rotation direction of the rotation unit and the number of the recognition block passed the sensing area of the pixel array within the rotation action.

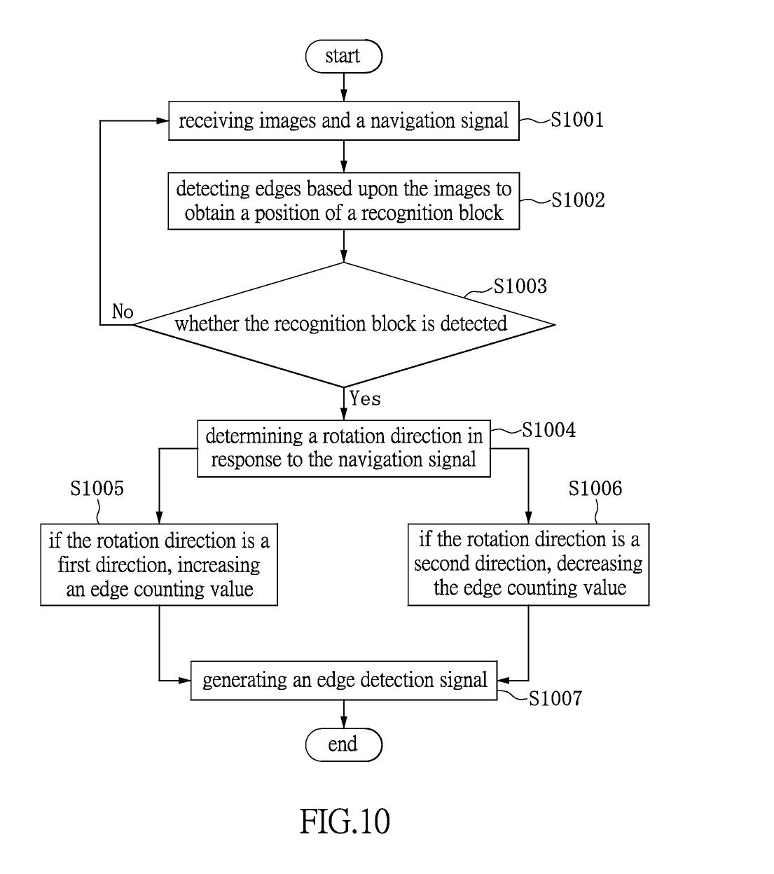

Please refer to FIG. 10, which shows a flow diagram illustrating a generation of an edge detection signal in accordance with an exemplary embodiment of the present disclosure. The method which FIG. 10 provided is applicable to the above edge detection units 103, 803. In step S1001, an edge detection unit receives images outputted by a pixel array and a navigation signal outputted by a navigation unit. In step S1002, the edge detection unit performs edge detection according to the images.

In step S1003, the edge detection unit determines whether a recognition block passes a sensing area of the pixel array. If the edge detection unit detects that the recognition block passes the sensing area, then step S1004 is executed. Conversely, if the edge detection unit does not detect that the recognition block passes the sensing area, then step S1001 is executed, and the edge detection unit continues receiving the images and the navigation signal. In step 1004, the edge detection unit determines a rotation direction of a rotation unit in response to the navigation signal. If the navigation signal instructs that the rotation direction is a first direction, then step S1005 is executed. If the navigation signal instructs that the rotation direction is a second direction, then step S1006 is executed.

In step S1005, an edge counting value recorded in an edge counter of the edge detection unit increases. In step S1006, the edge counting value recorded in the edge counter of the edge detection unit decreases. In step S1007, the edge detection unit generates an edge detection signal according to the edge counting value recorded in the edge counter.

In summary, compared to a conventional optical navigation sensor, the optical navigation sensor, the electronic device and the operation method provided by the present disclosure utilize the navigation unit to determine an amount of displacement of the rotation unit, and utilize the edge detection unit to detect the recognition block disposed on the surface of the rotation unit. By the rotation unit and the edge detection unit, the optical navigation sensor provided by the present disclosure can calculate the amount of displacement of the rotation unit more accurate, such that a back-end circuit can perform a corresponding action according to the calculated amount of displacement of the rotation unit.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An optical navigation sensor, configured for operatively sensing a surface of a rotation unit which the surface alternately disposing at least one recognition block, the optical navigation sensor comprises:
a pixel array configured for operatively capturing an image once every capturing interval;
a navigation unit coupled to the pixel array, configured for operatively generating a navigation signal according to the images, wherein the navigation signal comprises a rotation direction of the rotation unit;
an edge detection unit coupled to the pixel array and the navigation unit, configured for operatively generating an edge detection signal according to the images and the navigation signal, wherein the edge detection signal comprises a number of the recognition block which passes a sensing area of the pixel array;
wherein when the rotation unit performs a rotation action, the pixel array of the optical navigation sensor starts to capture the image associated with the surface; after receiving at least two images, the navigation unit determines the rotation direction of the rotation unit in response to the images which show a position variation of the recognition block in the images and generates the navigation signal; the edge detection unit receives the navigation signal and the images, and generates the edge detection signal in response to the rotation direction and the number of the recognition block which passes the sensing area.

2. The optical navigation sensor according to claim 1, wherein when the edge detection unit determines that the recognition block passes the sensing area and the rotation direction is a first direction, an edge counting value of the edge detection unit increases, and the edge detection unit generates the edge detection signal based upon the edge counting value; when the edge detection unit determines that the recognition block passes the sensing area and the rotation direction is a second direction, the edge counting value of the edge detection unit decreases, and the edge detection unit generates the edge detection signal based upon the edge counting value.

3. The optical navigation sensor according to claim 2, wherein the edge detection unit receives the images, and detects edges by a search-based edge detection or a zero-crossing based edge detection to obtain a plurality of positions of the recognition block in the images, and then the edge detection unit determines whether the recognition block passes the sensing area based upon the positions of the recognition block in the images.

4. The optical navigation sensor according to claim 2, wherein the edge counter is reset when the edge counting value reaches a specific value and the edge detection signal instructs the rotation unit rotates one cycle.

5. The optical navigation sensor according to claim 1, wherein a width of the recognition block is smaller than a size of the sensing area of the pixel array.

6. The optical navigation sensor according to claim 1, wherein a processing unit of the optical navigation sensor receives the navigation signal and the edge detection signal, and determines a rotation state of the rotation unit in response to the navigation signal and the edge detection signal to generate a rotation state signal, then the processing unit outputs the rotation state signal to a host, wherein the rotation state comprises the rotation direction of the rotation unit and the number of the recognition block passed the sensing area of the pixel array within the rotation action.

7. The optical navigation sensor according to claim 1, wherein a host receives the navigation signal and the edge detection signal, and determines a rotation state of the rotation unit in response to the navigation signal and the edge detection signal, wherein the rotation state comprises the rotation direction of the rotation unit and the number of the recognition block passed the sensing area of the pixel array within the rotation action.

8. The optical navigation sensor according to claim 1, wherein the optical navigation sensor further comprises an image processing unit which is coupled to the pixel array, the image processing unit configured for operatively receiving the images captured by the pixel array and performing an image processing on the images to correspondingly generate a plurality of second images, then the navigation unit and the edge detection unit respectively generates the navigation signal and the edge detection signal in response to the second images.

9. The optical navigation sensor according to claim 1, wherein the optical navigation sensor further comprises a speed sensor, the speed sensor is configured for operatively sensing a rotation speed of the rotation unit, and outputting the rotation speed to a host, then the host determines a rotation state of the rotation unit in response to the rotation speed, the navigation signal and the edge detection signal.

10. An electronic device with an optical navigation function, comprising:
a rotation unit comprising a surface, wherein at least one recognition block is alternately disposed on the surface, and light reflection coefficients between the surface and the recognition block are different; and
an optical navigation sensor configured for operatively sensing the surface, comprises:
a pixel array configured for operatively capturing an image once every capturing interval;
a navigation unit coupled to the pixel array, configured for operatively generating a navigation signal according to the images, wherein the navigation signal comprises a rotation direction of the rotation unit;
an edge detection unit coupled to the pixel array and the navigation unit, configured for operatively generating an edge detection signal according to the images and the navigation signal, wherein the edge detection signal comprises a number of the recognition block which passes a sensing area of the pixel array;
wherein when the rotation unit performs a rotation action, the pixel array of the optical navigation sensor starts to capture the image associated with the surface; after receiving at least two images, the navigation unit determines the rotation direction of the rotation unit in response to the images which show a position variation of the recognition block in the images and generates the navigation signal; the edge detection unit receives the navigation signal and the images, and generates the edge detection signal in response to the rotation direction and the number of the recognition block which passes the sensing area.

11. The electronic device according to claim 10, wherein the rotation unit is a dish structure or a ring structure.

12. An operation method of an electronic device, the electronic device comprising a rotation unit and an optical navigation sensor, and the optical navigation sensor comprising a pixel array, a navigation unit and an edge detection unit, the method comprising the steps of:
(a) at the rotation unit, performing a rotation action, wherein the rotation unit comprises a surface, and at least one recognition block is alternately disposed on the surface, and light reflection coefficients between the surface and the recognition block are different;
(b) at the pixel array, sensing the surface and capturing an image once every capturing interval;
(c) at the navigation unit, after receiving at least two images, determining a rotation direction of the rotation unit in response to the images which shows a position variation of the recognition block in the images, and generating a navigation signal, wherein the navigation signal comprises the rotation direction of the rotation unit;
(d) at the edge detection unit, receiving the navigation signal and the images, and generating an edge detection signal in response to the rotation direction and a number of the recognition block which passes a sensing area of the pixel array, wherein the edge detection signal comprises the number of the recognition block which passes the sensing area;
(e) determining a rotation state of the rotation unit in response to the navigation signal and the edge detection signal, wherein the rotation state comprises the rotation direction of the rotation unit and the number of the recognition block which passes the sensing area.

13. The operation method according to claim 12, wherein in step (d), when the edge detection unit determines that the recognition block passes the sensing area and the rotation direction is a first direction, an edge counting value of the edge detection unit increases, and the edge detection unit generates the edge detection signal based upon the edge counting value; when the edge detection unit determines that the recognition block passes the sensing area and the rotation direction is a second direction, the edge counting value of the edge detection unit decreases, and the edge detection unit generates the edge detection signal based upon the edge counting value.

14. The operation method according to claim 13, wherein the edge detection unit receives the images, and detects edges by a search-based edge detection or a zero-crossing based edge detection to obtain a plurality of positions of the recognition block in the images, and then the edge detection unit determines whether the recognition block passes the sensing area based upon the positions of the recognition block in the images.

15. The operation method according to claim 13, wherein the edge counter is reset when the edge counting value reaches a specific value and the edge detection signal instructs the rotation unit rotates one cycle.

16. The operation method according to claim 12, wherein a width of the recognition block is smaller than a size of the sensing area of the pixel array.

17. The operation method according to claim 12, wherein the rotation unit is a dish structure or a ring structure.

18. The operation method according to claim 12, wherein the operation method further comprising the steps of:
(f) at a processing unit of the optical navigation sensor, receiving the navigation signal and the edge detection signal, and determining the rotation state of the rotation unit in response to the navigation signal and the edge detection signal to generate a rotation state signal, then outputting the rotation state signal to a host, wherein the rotation state comprises the rotation direction of the rotation unit and the number of the recognition block passed the sensing area of the pixel array within the rotation action.

19. The operation method according to claim 12, wherein the operation method further comprising the steps of:
(f′) at a host, receiving the navigation signal and the edge detection signal, and determining the rotation state of the rotation unit in response to the navigation signal and the edge detection signal.

20. The operation method according to claim 12, wherein the step (b) further comprising the steps of:
(b-1) at an image processing unit of the optical navigation sensor, receiving the images captured by the pixel array and performing an image processing on the images to correspondingly generate a plurality of second images, then at the navigation unit and the edge detection unit, generating the navigation signal and the edge detection signal in response to the second images.

21. The operation method according to claim 12, wherein the step (e) further comprising the steps of:
(e-1) at a speed sensor of the optical navigation sensor, sensing a rotation speed of the rotation unit, and outputting the rotation speed to a host, then at the host, determining the rotation state of the rotation unit in response to the rotation speed, the navigation signal and the edge detection signal.
